(19) United States
(12) Patent Application Publication
(10) Pub. No.: US 2016/0094713 A1
(43) Pub. Date: Mar. 31, 2016

(54) COMMUNICATION MESSAGE RECOGNITION METHOD AND DEVICE THEREOF

(71) Applicant: Xiaomi Inc., Beijing (CN)

(72) Inventors: Huiyun LIU, Beijing (CN); Guangjian WANG, Beijing (CN); Zhiyong WANG, Beijing (CN)

(73) Assignee: Xiaomi Inc., Beijing (CN)

(21) Appl. No.: 14/867,895

(22) Filed: Sep. 28, 2015

Related U.S. Application Data
(63) Continuation of application No. PCT/CN2015/074654, filed on Mar. 20, 2015.

(30) Foreign Application Priority Data
Sep. 30, 2014 (CN) 201410520101.1

(51) Int. Cl. H04M 3/42; H04W 4/14

(52) U.S. Cl. CPC H04M 3/42382; H04W 4/14

(57) ABSTRACT

A message recognition method and corresponding device are provided. In the method, the device receives a message, which includes text content and a number associated with a sender of the message. The device analyzes the text content of the message and acquires a user name corresponding to the number associated with the sender. The device determines the user name as the communication message sender's name and displays the sender's name in the message.

### CROSS-REFERENCE TO RELATED APPLICATIONS

The present application is a continuation of International Application No. PCT/CN2015/074654, filed Mar. 20, 2015, which is based on and claims priority to Chinese Patent Application No. 201410520101.1, filed Sep. 30, 2014, the entire contents of which are incorporated herein by reference.

### TECHNICAL FIELD

The present disclosure generally relates to the field of data analysis technique, and more particularly, to a communication message recognition method and a device thereof.

### BACKGROUND

Both individual users and merchants widely use short messages (or SMS messages) for communication. However, there is a difference between a merchant SMS number and an individual user SMS number, and one merchant SMS number may automatically generate several different numbers during sending SMS messages, which causes great recognition difficulty to users.

In order to facilitate a user recognizing the merchant who sent an SMS message, related public merchant numbers may include collected manually, and merchant SMS numbers and names verified manually may include stored in a yellow page database. When a terminal receives an SMS message from a stranger, it may acquire the message sender's number and query the number of the sender in the yellow page database, and display on the user terminal a preset merchant name corresponding to the number of the sender.

However, the related technologies have following disadvantages: it is difficult to timely refresh the preset yellow page database as related public merchant numbers needs to be collected manually, thus leading to a low recognition rate or a high recognition error ratio.

### SUMMARY

According to a first aspect of the present disclosure, there is provided a message recognition method. The method include: receiving a message, which includes text content and a number of a sender who sends the communication message; analyzing the text content of the message and acquiring a user name corresponding to the number associated with the sender of the message; and determining the user name as the message sender's name and displaying the sender's name in the message.

According to a second aspect of the present disclosure, there is provided a communication message recognition device. The device includes: a processor; and a memory configured to store instructions executable by the processor. The processor is configured to perform: receiving a communication message, which includes text content and communication message sender's number; analyzing the text content of the communication message and acquiring a user name corresponding to the number of the communication message sender; and determining the user name as the communication message sender's name and displaying the sender's name in the communication message.

According to a third aspect of the present disclosure, there is provided a non-transitory storage medium having stored therein instructions that, when executed by a processor of an electronic device, cause the electronic device to perform a communication message recognition method. The method includes: receiving a communication message, which comprises text content and a number of a sender who sends the communication message; analyzing the text content of the communication message and acquiring a user name corresponding to the number of the communication message sender and determining the user name as a name of the communication message sender and displaying the name of the sender in the communication message.

It will be appreciated that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic diagram illustrating an implementation environment of a communication message recognition method according to exemplary embodiments.

FIG. 2 is a flow chart of a communication message recognition method according to an exemplary embodiment.

FIG. 3A is a flow chart of a communication message recognition method according to another exemplary embodiment.

FIG. 3B is a schematic diagram illustrating how a terminal displays a user name according to an exemplary embodiment.

FIG. 4A is a flow chart of a communication message recognition method according to a further exemplary embodiment.

FIG. 4B is a schematic diagram illustrating how a terminal displays a user name according to an exemplary embodiment.

FIG. 5A is a flow chart of a communication message recognition method according to a still further exemplary embodiment.

FIG. 5B is a schematic diagram illustrating how a terminal displays a user name according to an exemplary embodiment.

FIG. 6A is a flow chart of a communication message recognition method according to another exemplary embodiment.

FIG. 6B is a schematic diagram illustrating how a terminal displays a user name according to an exemplary embodiment.

FIG. 7 is a block diagram of a communication message recognition device according to an exemplary embodiment.

FIG. 8 is a block diagram of a communication message recognition device according to another exemplary embodiment.

FIG. 9 is a block diagram of a communication message recognition device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

In order to solve the problem in related technologies that it is difficult to timely refresh a preset yellow page database thus leading to a high recognition error ratio, the present disclosure provides a communication message recognition method and a device thereof. The technical scheme according to embodiments of the disclosure may have the following beneficial effects:

A user name corresponding to a number of a sender who sends the communication message is acquired by receiving a communication message and analyzing the text content of the communication message, and the user name is determined as the communication message sender's name and is displayed. The communication message recognition method can acquire a user name according to the text content of a communication message, thus solving the problem that it is difficult to timely refresh a preset yellow page database thus leading to a high recognition error ratio, and reaching an effect of improving accuracy in recognition of communication messages.

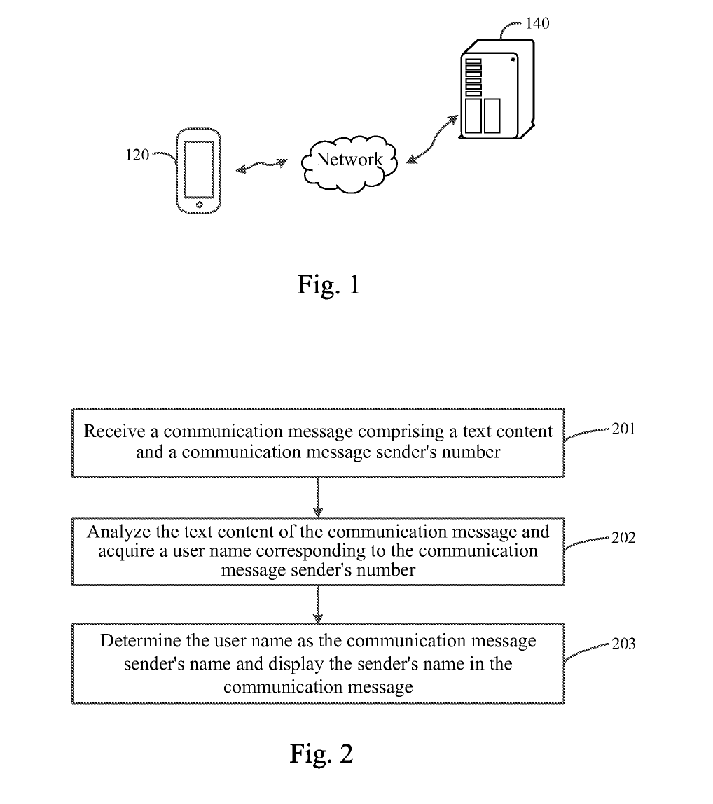

FIG. 1 is a schematic diagram illustrating an implementation environment of a communication message recognition method according to exemplary embodiments. As shown in FIG. 1, the implementation environment may include a terminal 120 and a server 140.

The terminal 120 may include an electronic device for receiving and saving a communication message. And the electronic device may include a smart mobile phone, a tablet computer, a smart television, an e-book reader, a multimedia player, a laptop computer, a desktop computer, or the like.

The terminal 120 is connected to the server 140 through wireless network or wired network.

The server 140 may include a server configured to analyze a communication message and acquire a user name. The server 140 may include a server, or a server cluster including a plurality of servers, or a cloud computing service center.

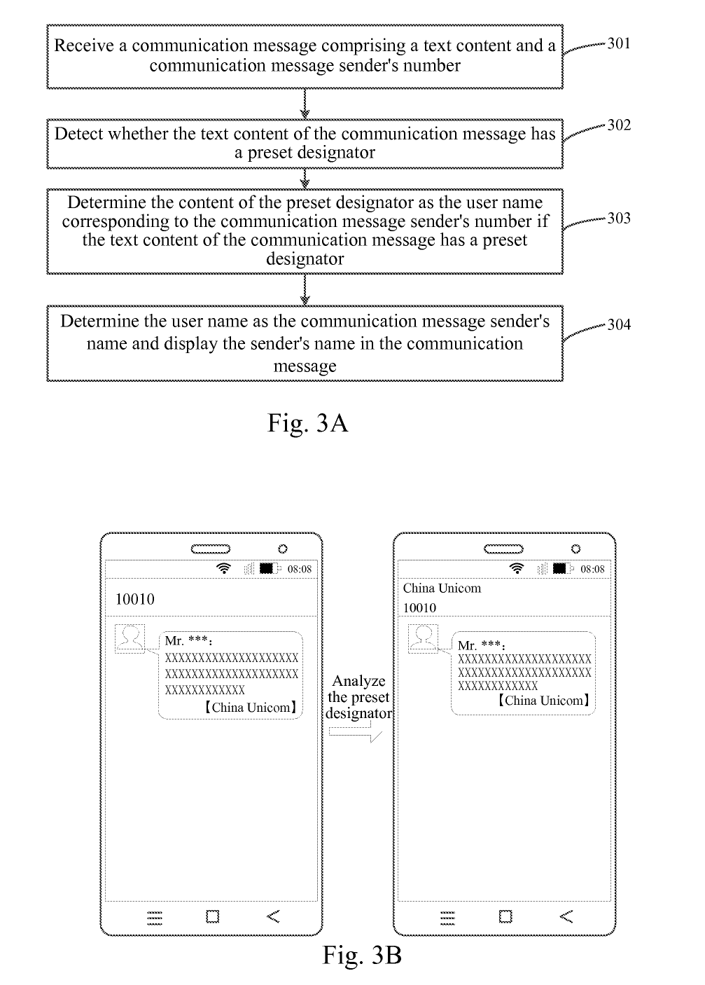

FIG. 2 is a flow chart of a communication message recognition method according to an exemplary embodiment. As shown in FIG. 2, the communication message recognition method may be implemented at least partially by a terminal capable of receiving a communication message, such as a smart mobile phone, a tablet computer, a smart television, an e-book reader, a multimedia player, a laptop computer, a desktop computer and so on. The communication message recognition method includes following steps for the terminal to perform.

In Step 201, a communication message is received, which includes text content and a number of a sender who sends the communication message. For example, the terminal may receive the communication message including a promotion from a merchant.

In Step 202, the text content of the communication message is analyzed and a user name corresponding to the number of the communication message sender is acquired. The terminal may analyze the received communication message according to preset rules. The terminal may obtain the user names from a local database or a database stored in a server.

In Step 203, the user name is determined as the communication message sender's name and the sender's name is displayed in the communication message. The terminal may display the sender's name at the beginning of the communication message or at the end of the communication message. The particular location of the displayed name may include customized by the user of the terminal.

In the disclosed communication message recognition method, the terminal acquires a user name corresponding to a number of a sender who sends the communication message by receiving a communication message and analyzing the text content of the communication message. The terminal may determine the user name as the communication message sender's name and display it. Using this method, the problem that it is difficult to timely refresh a preset yellow page database thus leading to a high recognition error ratio is solved, reaching an effect of improving accuracy in recognition of communication messages.

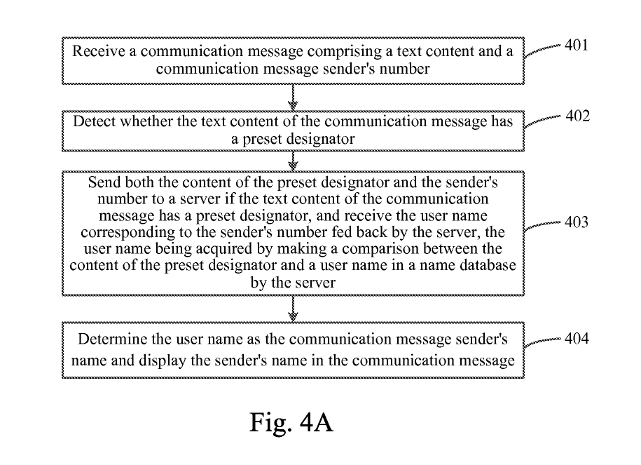

FIG. 3A is a flow chart of a communication message recognition method according to another exemplary embodiment. As shown in FIG. 3A, the communication message recognition method may be implemented at least partially by a terminal capable of receiving a communication message, such as a smart mobile phone, a tablet computer, a smart television, an e-book reader, a multimedia player, a laptop computer, a desktop computer and so on. The communication message recognition method includes following steps for the terminal to perform.

In Step 301, a communication message is received, which includes text content and a number of a sender who sends the communication message.

The communication message mentioned herein may include a message communicated in the form of text, for example, an SMS message.

In Step 302, it is detected whether the text content of the communication message has a preset designator.

The preset designator mentioned herein refers to symbols for highlighting a certain text content so as to distinguish the text content from other texts. For example, a user name necessary to be highlighted is marked by preset designators such as “ [symbol] [symbol] ,” “[ ]” or “( )” in the text content. For example, if “China Unicom” needs highlighting, it may include indicated as “ [symbol] China Unicom [symbol] ,” “[China Unicom]” or “(China Unicom),” etc.

The preset designator may also include an underline, a wavy line, or double quotation marks and the like. The present embodiment does not limit the type of a preset designator.

In Step 303, the content of the preset designator is determined as the user name corresponding to the number of the communication message sender if the text content of the communication message has a preset designator.

After detecting that the text content of the communication message has a preset designator, the terminal extracts the content of the preset designator and determines the content extracted as the user name corresponding to the number of the communication message sender.

For example, during detecting the text content of a communication message with a sender's number of 10010, the terminal finds a preset designator “ [symbol] [symbol] ,” the terminal extracts the content (“China Unicom”) of “ [symbol] [symbol] ” and determines “China Unicom” as the user name corresponding to the number of the sender 10010.

In Step 304, the user name is determined as the communication message sender's name and the sender's name is displayed in the communication message.

The terminal determines a user name extracted from a preset designator as a communication message sender's name and replaces a sender's number in a corresponding communication message by the sender's name for display. Alternatively or additionally, the terminal may also simultaneously display the sender's name and a sender's number corresponding to the sender's name so as to facilitate a user viewing the number of the sender.

For example, FIG. 3B is a schematic diagram illustrating how a terminal displays a user name according to an exemplary embodiment. In FIG. 3B, after receiving the communication message sent by the number of the sender 10010, the terminal detects the text content of the communication message and finds that a preset designator “ [symbol] [symbol] ” exists in the text content, and the terminal extracts the content (i.e., “China Unicom”) of the preset designator “ [symbol] [symbol] .” At the moment, the terminal determines “China Unicom” as the communication message sender's name, and displays the sender's name “China Unicom” in an area for displaying a sender's number in the communication message. Meanwhile, in order to facilitate users viewing the number of the sender corresponding to the sender's name, the terminal reserves the number of the communication message sender 10010 in the area for displaying a sender's number, and displays it below the sender's name “China Unicom.”

It is worth explaining that the communication message recognition method provided in the present embodiment is particularly applicable to the case in which the message sender is a merchant. Generally, when a merchant sends a communication message of notice type to an individual user, the sender's name of the current message is marked with “ [symbol] [symbol] ” at the end of the message content. According to the method provided in the present embodiment, when a message from a strange merchant is received, a name in “ [symbol] [symbol] ” at the end of the message content may include determined as the message sender's name, which may include displayed to a user, thus reaching an effect of identifying the sender's name.

In the disclosed communication message recognition method, the terminal may acquire a user name corresponding to a number of a sender who sends the communication message by receiving a communication message and analyzing the text content of the communication message. The terminal may determine the user name as the communication message sender's name and display. The disclosed method solves the problem that it is difficult to timely refresh a preset yellow page database. Thus, the recognition error ratio is reduced and the accuracy in recognition of communication messages is increased.

In the communication message recognition method, the terminal detects whether the text content of a communication message includes a preset designator. Thus, the terminal may determine the content of the preset designator as a user name corresponding to a number of a sender who sends the communication message. This method solves the problem that for determining the user name corresponding to a number of a sender who sends the communication message it is necessary to send the number of the sender to a server for making a comparison in the database thus acquiring the user name (which is not only cumbersome in steps but also wastes time), and reaching an effect of improving efficiency in recognition of communication messages.

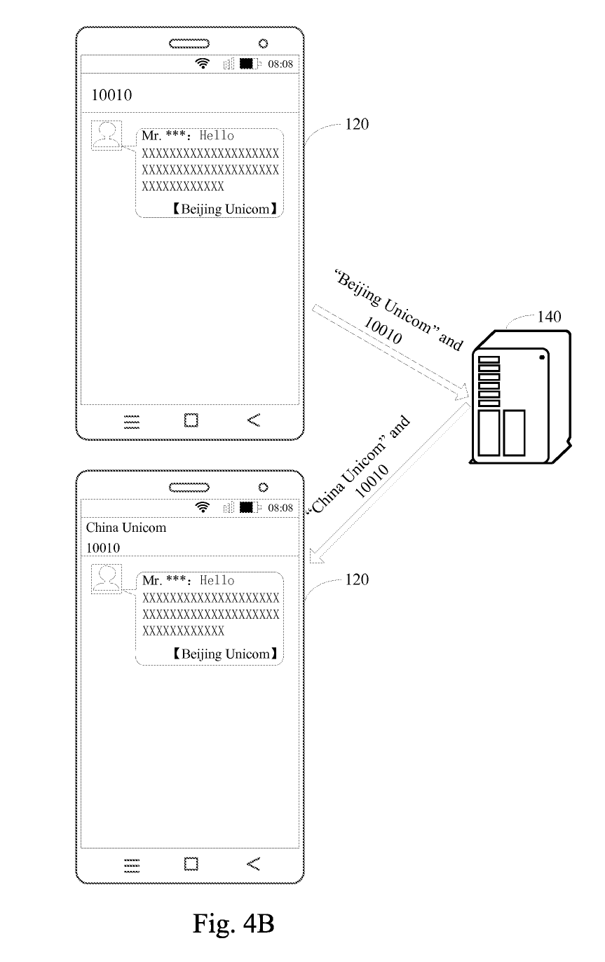

Alternatively or additionally, when a communication message has at least two or two pairs of preset designators, the terminal may obtain two or more than two contents of the preset designators. If these obtained contents are different, in order to further improve the accuracy, the terminal may send these contents of the preset designators to a server. The server may determine which content may serve as the user name. Please refer to FIG. 4A for details.

FIG. 4A is a flow chart of a communication message recognition method according to another exemplary embodiment. As shown in FIG. 4A, the communication message recognition method may be implemented at least partially by a terminal 120 in the implementation environment as shown in FIG. 1. The method may include following steps for the terminal to perform.

In Step 401, a communication message is received, which includes text content and a number of a sender who sends the communication message.

The communication message mentioned herein may include a message communicated in the form of text, for example, an SMS message.

In Step 402, it is detected whether the text content of the communication text message has a preset designator.

The preset designator mentioned herein refers to symbols for highlighting a certain text content so as to distinguish the text content from other texts. For example, a user name necessary to be highlighted is marked by preset designators such as “ [symbol] [symbol] ,” “[ ]” or “( )” in text content. For example, if “China Unicom” needs highlighting, it may include indicated as “ [symbol] China Unicom [symbol] ,” “[China Unicom]” or “(China Unicom),” etc.

The preset designator may include different formats which include an underline, a wavy line, or double quotation marks and the like. The present embodiment does not limit the type of a preset designator.

In Step 403, both the content of the preset designator and the number of the sender are sent to a server if the text content of the communication message has a preset designator, and then the user name corresponding to the number of the sender fed back by the server is received. The user name is acquired by the server by making a comparison between the content of the preset designator and a user name in a name database.

After detecting that the text content of the communication message includes a preset designator, the terminal may extract the content of the preset designator and send the content extracted and the number of the sender to the server.

After receiving the content of the preset designator and the number of the sender sent by the terminal, the server detects the content of the preset designator, thus determining whether the content of the preset designator is matched with a user name stored in the name database.

The name database stores at least one user name, and stores an associated word corresponding to each user name. The associated word is a participle associated to a user name, and a user name may include corresponding to a plurality of associated words. For example, a user name is “China Unicom,” associated words corresponding to the user name may include “Beijing Unicorn,” “Shanghai Unicorn” and “Unicorn users,” etc.

After acquiring the content of a preset designator, the server may directly match the content with a user name stored in the name database, or match the content with an associated word corresponding to a user name stored in the name database.

If the content of a preset designator is matched with a user name stored in the name database or an associated word corresponding to the user name, the server determines the content of the preset designator as a user name, and acquires a user name matched with the content of the preset designator, or acquires a user name corresponding to an associated word matched with the content of the preset designator.

After determining the user name, the server feeds back the user name and the number of the sender corresponding to the user name to the terminal, so the terminal receives the user name corresponding to the number of the sender.

In Step 404, the user name is determined as the communication message sender's name and the sender's name is displayed in the communication message.

After receiving a user name corresponding to a sender's number fed back by the server, the terminal determines the user name as a communication message sender's name and replaces a sender's number in a corresponding communication message by the sender's name for display. Alternatively or additionally, the terminal may also simultaneously display the sender's name and a sender's number corresponding to the sender's name so as to facilitate a user viewing the number of the sender.

For example, please refer to FIG. 4B, which is a schematic diagram illustrating how a terminal displays a user name according to an exemplary embodiment. As shown in FIG. 4B, after receiving the communication message sent by the number of the sender 10010, the terminal 120 detects the text content of the communication message and finds that a preset designator “ [symbol] [symbol] ” exists in the text content, and the terminal 120 extracts the content (i.e., “Beijing Unicorn”) of the preset designator “ [symbol] [symbol] .” The terminal 120 sends “Beijing Unicorn” extracted and the number of the sender 10010 to the server 140. After receiving “Beijing Unicorn” and the number of the sender 10010, the server 140 matches “Beijing Unicorn” with a user name in the name database and acquires a user name “China Unicorn,” at the moment, the server 140 feeds the user name “China Unicorn” acquired from matching and the number of the sender 10010 back to the terminal 120. After receiving the user name “China Unicorn” and the number of the sender 10010, the terminal 120 determines the user name “China Unicorn” as the sender's name, and displays the sender's name “China Unicorn” in the area for displaying a sender's number in the communication message. Meanwhile, in order to facilitate users viewing the number of the sender corresponding to the sender's name, the terminal 120 reserves the number of the communication message sender 10010 in the area for displaying a sender's number, and displays it below the sender's name “China Unicom.”

In the disclosed communication message recognition method, the terminal may acquire a user name corresponding to a number of a sender who sends the communication message by receiving a communication message and analyzing the text content of the communication message. The terminal may determine the user name as the communication message sender's name and display it. Using this method, it is solved the problem that it is difficult to timely refresh a preset yellow page database thus leading to a high recognition error ratio, and reaching an effect of improving accuracy in recognition of communication messages.

In the disclosed communication message recognition method, the terminal detects whether the text content of a communication message includes a preset designator. When the text content of the communication message includes the preset designator, the terminal sends both the content of the preset designator and the number of the sender to the server and receives the user name corresponding to the number of the sender fed back by the server. Thus, the terminal may acquire a user name by the server according to the content of the preset designator sent to the server. The disclosed method solves the problem that the content of a preset designator may include not an accurate user name thus leading to communication message recognition error. The disclosed method thus improves accuracy in recognition of communication messages.

In FIGS. 3A and 4A, the terminal may acquire the communication message sender's name by means of the content of a preset designator in the text content of the communication message. Alternatively or additionally, the terminal may conduct a term partitioning of the text content of the communication message, and acquire the communication message sender's name according to an independent term acquired from term partitioning.

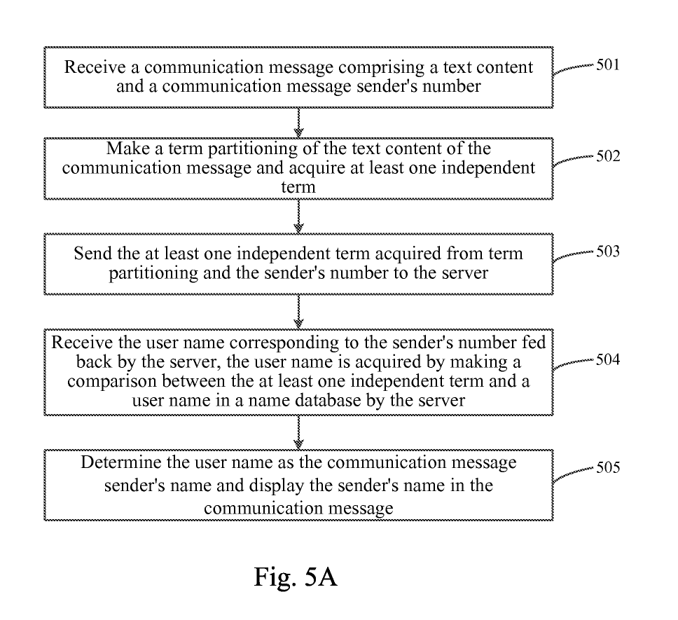

FIG. 5A is a flow chart of a communication message recognition method according to a further exemplary embodiment. As shown in FIG. 5A, the communication message recognition method may be implemented at least partially by the terminal 120 in the implementation environment as shown in FIG. 1, including following steps for the terminal to perform.

In Step 501, a communication message is received, which includes text content and a number of a sender who sends the communication message.

The communication message mentioned herein may include a message communicated in the form of text, for example, an SMS message.

In Step 502, a term partitioning of the text content of the communication message is made and at least one independent term is acquired.

At the time of analyzing the text content of the communication message, the terminal may make a term partitioning of the text content of the communication message and acquire independent terms.

In Step 503, at least one independent term acquired from term partitioning and the number of the sender are sent to the server.

After conducting a term partitioning of the text content of the communication message and acquiring independent terms, the terminal sends these independent terms and the number of the sender to the server.

After receiving independent terms and the number of the sender, the server analyzes whether associated user names exist in these independent terms. At the moment, the server may match independent terms acquired with associated words stored in the name database. Once an independent term is matched with a certain associated word, the server determines that the independent term is associated with the user name corresponding to the associated word. And the server determines the user name as the user name corresponding to the number of the sender.

In Step 504, the user name corresponding to the number of the sender fed back by the server is received. The user name is acquired by the server by making a comparison between at least one independent term and a user name in a name database.

After determining the user name corresponding to the number of the sender according to independent terms received, the server feeds both the number of the sender and the user name corresponding to the number of the sender back to the terminal.

And the terminal receives the number of the sender and the user name corresponding to the number of the sender.

In Step 505, the user name is determined as the communication message sender's name and the sender's name is displayed in the communication message.

After receiving the number of the sender and the user name corresponding to the number of the sender, the terminal determines the user name as the corresponding communication message sender's name, and replaces a sender's number in a corresponding communication message by the sender's name for display. Alternatively or additionally, the terminal may also simultaneously display the sender's name and a sender's number corresponding to the sender's name so as to facilitate a user viewing the number of the sender.

For example, please refer to FIG. 5B, which is a schematic diagram illustrating how a terminal displays a user name according to an exemplary embodiment. As shown in FIG. 5B, after conducting a term partitioning of the text content and acquiring independent terms, the terminal 120 sends these independent terms and the number of the sender 10010 to the server 140. After receiving independent terms and the number of the sender 10010, the server 140 matches these independent terms with associated words stored in the name database, thus acquiring the user name “China Unicom” corresponding to the number of the sender 10010, and feeds the user name “China Unicom” and the corresponding sender's number 10010 back to the terminal 120. After receiving the user name “China Unicom” and the number of the sender 10010, the terminal 120 determines the user name “China Unicom” as the sender's name, and displays the sender's name “China Unicom” in the area for displaying a sender's number in the communication message. Meanwhile, in order to facilitate users viewing the number of the sender corresponding to the sender's name, the terminal 120 reserves the number of the sender 10010 of the communication message in the area for displaying a sender's number, and displays it below the sender's name “China Unicom.”

In the disclosed communication message recognition method above, the terminal may acquire a user name corresponding to a number of a sender who sends the communication message by receiving a communication message and analyzing the text content of the communication message. The terminal may determine the user name as the communication message sender's name and display it. Because a user name can be acquired according to the text content of a communication message, it is solved the problem that it is difficult to timely refresh a preset yellow page database thus leading to a high recognition error ratio, and reaching an effect of improving accuracy in recognition of communication messages.

The communication message recognition method described herein, by conducting a term partitioning of the text content of a communication message, sending at least one independent term acquired from term partitioning and the number of the sender to the server, can receive the user name corresponding to the number of the sender fed back by the server. This method solves the problem that it wastes time to establish a database including the user name corresponding to the number of the sender in the server. The method determines and acquires the user name corresponding to the number of the sender available and thus improves efficiency in recognition of communication messages.

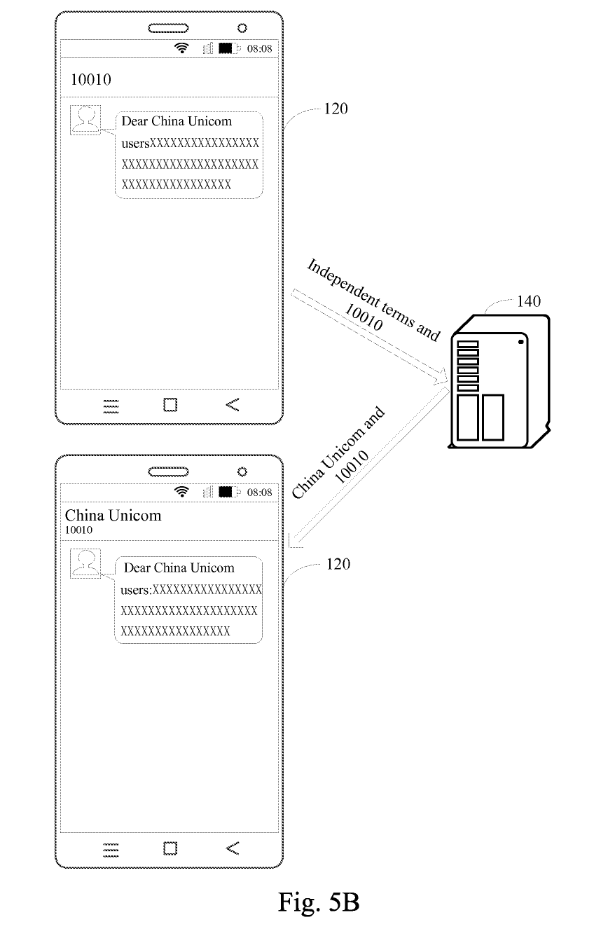

In a possible embodiment, the terminal may acquire an executor's name by making a semantic analysis of the text content of a communication message, and determine the executor's name as the user name corresponding to the communication message. Please refer to the embodiment in FIG. 6A for concrete implementation.

FIG. 6A is a flow chart of a communication message recognition method according to a further exemplary embodiment. As shown in FIG. 6A, the communication message recognition method may be implemented at least partially by a terminal capable of receiving a communication message, for example, a smart mobile phone, a tablet computer, a smart television, an e-book reader, a multimedia player, a laptop computer, a desktop computer and the like. The communication message recognition method includes following steps for the terminal to perform.

In Step 601, a communication message is received, which includes text content and a number of a sender who sends the communication message.

The communication message mentioned herein may include a message communicated in the form of text, for example, a communication message.

In Step 602, a semantic analysis of the text content of the communication message is made and an executor′ name of the text content is acquired, and the executor's name is determined as the user name corresponding to the number of the communication message sender.

After receiving the communication message, the terminal may make a semantic analysis of the text content of the communication message received via a semantic analysis model, so as to acquire an executor′ name of the text content, and then determine the executor's name as the user name corresponding to the number of the communication message sender.

For example, the terminal receives such a communication message as “Mr. Zhang wishes you a happy National Day!” At the moment, the terminal makes a semantic analysis of the text content by means of the semantic analysis model, thus acquiring an executor′ name of the text content “Mr. Zhang,” and determines the executor's name “Mr. Zhang” as the user name corresponding to the number of the communication message sender.

Alternatively or additionally, the terminal may make a semantic analysis by using a semantic analysis model which is acquired from a server providing a semantic analysis model. The server may conduct a training according to samples of known semantic information collected, thus acquiring a semantic analysis model.

In Step 603, the user name is determined as the communication message sender's name and the sender's name is displayed in the communication message.

The terminal determines the user name acquired from the semantic analysis model upon analysis as the communication message sender's name and displays the sender's name in the communication message.

For example, please refer to FIG. 6B, which is a schematic diagram illustrating how a terminal displays a user name according to an exemplary embodiment. As shown in FIG. 6B, after receiving the communication message sent by the number of the sender 156****0351, the terminal acquires such text content as “Mr. Zhang wishes you a happy National Day!” The terminal makes a semantic analysis of the text content by means of the semantic analysis model, and acquires an executor′ name of the text content “Mr. Zhang.” At the moment, the terminal determines the executor's name “Mr. Zhang” as the user name corresponding to the number of the communication message sender, also determines the user name “Mr. Zhang” as the communication message sender's name, and displays the sender's name “Mr. Zhang” in the area for displaying a sender's number in the communication message. Meanwhile, in order to facilitate users viewing the number of the sender corresponding to the sender's name, the terminal reserves the number of the communication message sender 156****0351 in the area for displaying a sender's number, and displays it below the sender's name “Mr. Zhang.”

In the disclosed communication message recognition method, the terminal may acquire a user name corresponding to a number of a sender who sends the communication message by receiving a communication message and analyzing the text content of the communication message. The terminal thus may determine the user name as the communication message sender's name and display it. This method solves the problem that it is difficult to timely refresh a preset yellow page database thus leading to a high recognition error ratio, and reaching an effect of improving accuracy in recognition of communication messages.

In the disclosed communication message recognition method, the terminal may make a semantic analysis of the text content of a communication message and acquire an executor′ name of the text content. Thus, the terminal may determine the executor's name as a user name corresponding to a number of a sender who sends the communication message. The method may not need to involve a server and a large database because the user name can be determined by only making a semantic analysis of the text content. Thus, the method solves the problem that a server and a corresponding database are required for determining the user name corresponding to the number of the sender (which is not only cumbersome in steps but also wastes time), and reaches an effect of improving efficiency in recognition of communication messages.

Further, the terminal may send the number of the sender and a corresponding relationship between the number of the sender and the user name corresponding to the number of the sender to the server, which stores the corresponding relationship in a corresponding relational database.

The corresponding relational database includes at least one set of corresponding relationship each of which may include a sender's number and a user name corresponding to the number of the sender.

Alternatively or additionally, after acquiring the number of the sender and the corresponding relationship between the number of the sender and the user name corresponding to the number of the sender, the server does not directly store the corresponding relationship in the corresponding relational database, instead it may temporarily store the corresponding relationship, then make an analysis of sender's names and sender's numbers stored temporarily, and bound and store reliable sender's names and sender's numbers in the corresponding relational database.

It should also be explained that data transmission between the terminal and the server may be encrypted, and data storage at server-side may also be encrypted, thus preventing users' privacy leaks and guaranteeing user information security.

The following are embodiments of the device in the present disclosure, which may include configured to carry out the embodiments of the method in the present disclosure. Please refer to the embodiments of the method in the present disclosure with regard to undisclosed details about the embodiments of the device in the present disclosure.

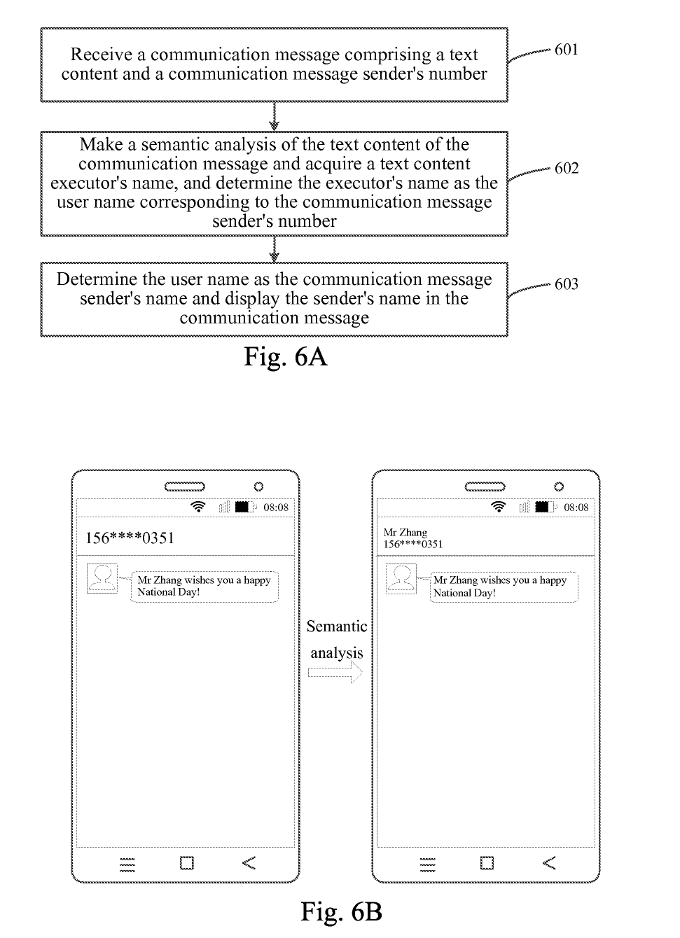

FIG. 7 is a block diagram of a communication message recognition device according to an exemplary embodiment. As shown in FIG. 7, the communication message recognition device may be implemented by a terminal capable of receiving a communication message, for example, a smart mobile phone, a tablet computer, a smart television, an e-book reader, a multimedia player, a laptop computer, a desktop computer and the like. The communication message recognition device includes but is not limited to: a receiving module 702, an analysis module 704 and a display module 706.

The receiving module 702 is configured to receive a communication message including text content and a number of a sender who sends the communication message.

The analysis module 704 is configured to analyze the text content of the communication message and acquire a user name corresponding to the number of the communication message sender.

The display module 706 is configured to determine the user name as the communication message sender's name and display the sender's name in the communication message.

In the disclosed communication message recognition device above, the terminal may acquire a user name corresponding to a number of a sender who sends the communication message by receiving a communication message and analyzing the text content of the communication message. The terminal thus can determine the user name as the communication message sender's name and display it, thereby solving the problem that it is difficult to timely refresh a preset yellow page database thus leading to a high recognition error ratio, and reaching an effect of improving accuracy in recognition of communication messages.

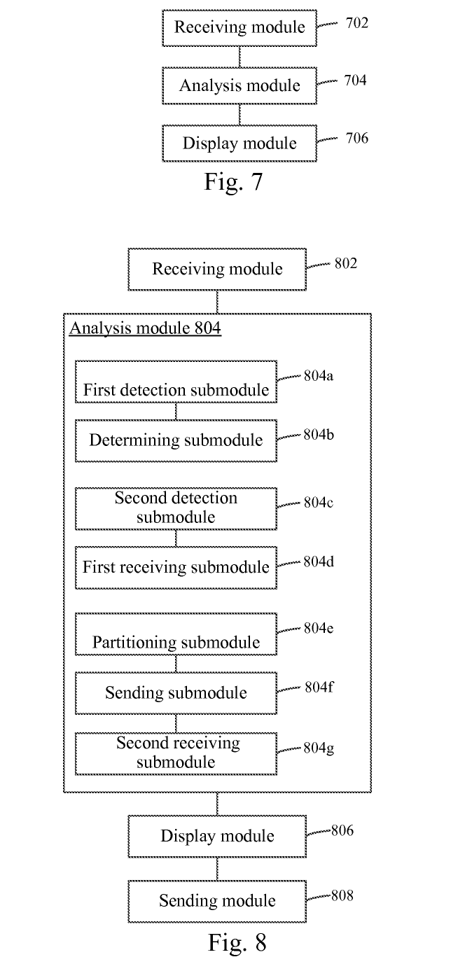

FIG. 8 is a block diagram of a communication message recognition device according to another exemplary embodiment. As shown in FIG. 8, the communication message recognition device may be implemented by the terminal 120 in the implementation environment as shown in FIG. 1. The communication message recognition device may include but is not limited to: a receiving module 802, an analysis module 804 and a display module 806.

The receiving module 802 is configured to receive a communication message including text content and communication message sender's number.

The analysis module 804 is configured to analyze the text content of the communication message received by the receiving module 802, thus acquiring a user name corresponding to the number of the communication message sender.

The display module 806 is configured to determine the user name acquired from the analysis module 804 upon analysis as the communication message sender's name and to display the sender's name in the communication message.

In a possible embodiment, the analysis module 804 may include: a first detection submodule 804a and a determining submodule 804b.

The first detection submodule 804a is configured to detect whether the text content of the communication message has a preset designator.

The determining submodule 804b is configured to determine the content of the preset designator as the user name corresponding to the number of the communication message sender if the first detection submodule 804a detects that the text content of the communication message has a preset designator.

In a possible embodiment, the analysis module 804 may include: a second detection submodule 804c and a first receiving submodule 804d.

The second detection submodule 804c is configured to detect whether the text content of a communication message has a preset designator.

The first receiving submodule 804d is configured to send both the content of the preset designator and the number of the sender to a server if the second detection submodule 804c detects that the text content of the communication message has a preset designator, and to receive the user name corresponding to the number of the sender fed back by the server. The user name is acquired by the server by making a comparison between the content of the preset designator and a user name in a name database.

In a possible embodiment, the analysis module 804 is configured to make a semantic analysis of the text content of a communication message and acquire an executor′ name of the text content, and to determine the executor's name as the user name corresponding to the number of the communication message sender.

In a possible embodiment, the analysis module 804 may include: a partitioning submodule 804e, a sending submodule 804f and a second receiving submodule 804g.

The partitioning submodule 804e is configured to make a term partitioning of the text content of a communication message, thus acquiring at least one independent term.

The sending submodule 804f is configured to send at least the one independent term acquired from the partitioning submodule 804e upon term partitioning and the number of the sender to the server.

The second receiving submodule 804g is configured to receive the user name corresponding to the number of the sender fed back by the server. The user name is acquired by the server by making a comparison between the at least one independent term and a user name in a name database.

In a possible embodiment, the communication message recognition device further includes: a sending module 808.

The sending module 808 is configured to send the number of the sender and a corresponding relationship between the number of the sender and the user name corresponding to the number of the sender to the server for storing the corresponding relationship in a corresponding relational database including at least one set of corresponding relationship each of which includes a sender's number and a user name corresponding to the number of the sender.

In the communication message recognition device, the terminal may acquire a user name corresponding to a number of a sender who sends the communication message by receiving a communication message and analyzing the text content of the communication message. The terminal may determine the user name as the communication message sender's name and display it, thereby solving the problem that it is difficult to timely refresh a preset yellow page database thus leading to a high recognition error ratio, and reaching an effect of improving accuracy in recognition of communication messages.

With regard to the device in the disclosure, detailed description of specific modes for conducting operation of modules has been made in the embodiments related to the method described above, no detailed illustration will be made herein.

An exemplary embodiment of the present disclosure provides a communication message recognition device, available for implementing the communication message recognition method provided by the present disclosure. And the communication message recognition device includes: a processor and a memory configured to store instructions executable by the processor.

Here, the processor may include configured to: receive a communication message, which includes text content and communication message sender's number; analyze the text content of the communication message and acquire a user name corresponding to the number of the communication message sender; and determine the user name as the communication message sender's name and display the sender's name in the communication message.

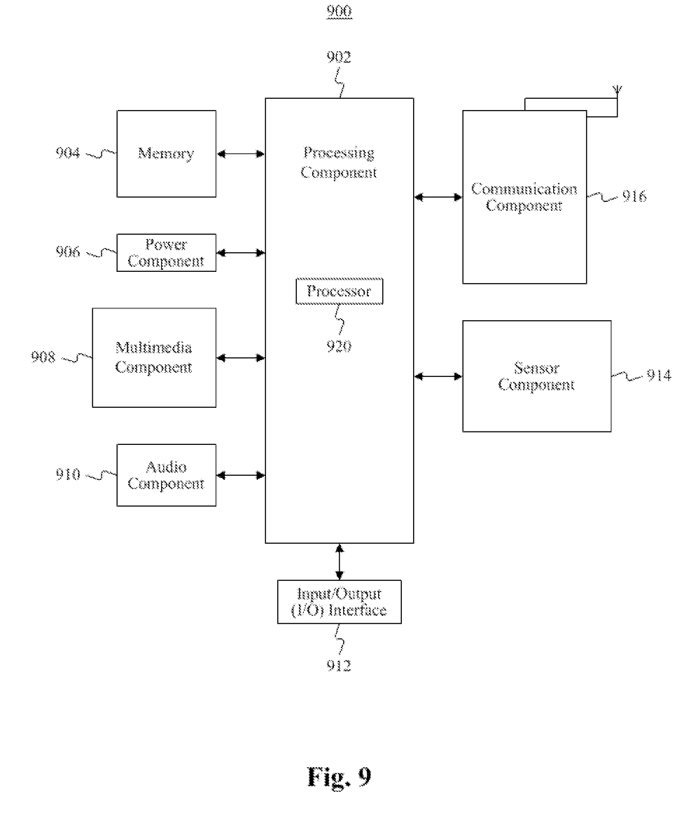

FIG. 9 is a block diagram of a communication message recognition device according to an exemplary embodiment. For example, the device 900 may include a mobile telephone, a computer, a digital broadcasting terminal, a message transceiver device, a games console, a tablet device, a medical device, a fitness facility, a PDA (personal digital assistant) and the like.

Referring to FIG. 9, the device 900 may include one or a plurality of components as below: a processor component 902, a memory 904, a power supply component 906, a multimedia component 908, an audio component 910, an input/output (I/O) interface 912, a sensor component 914 and a communication component 916.

The processor component 902 usually controls the overall operation of the device 900, for example, display, telephone call, data communication, and operation associated with camera operation and record operation. The processor component 902 may include one or a plurality of processors 918 for executing instructions so as to complete steps of above method in part or in whole. In addition, the processor component 902 may include one or a plurality of modules for the convenience of interaction between the processor component 902 and other components. For example, the processor component 902 may include a multimedia module for the convenience of interaction between the multimedia component 908 and the processor component 902.

The memory 904 is configured to store data of different types so as to support the operation of the device 900. Examples of the data include any application program or approach for operation of the device 900, including instructions, contact data, phonebook data, message, picture and video, etc. The memory 904 may include realized by volatile or non-volatile memory device of any type or combination thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The power supply component 906 provides power for components of the device 900. The power supply component 906 may include a power management system, one or a plurality of power supplies, and other components associated with power generation, management and distribution of the device 900.

The multimedia component 908 includes a screen provided between the device 900 and a user for providing an output interface. In some embodiments, the screen may include an LCD (Liquid Crystal Display) and a touch panel (TP). If the screen includes a touch panel, the screen may include realized as a touch screen for receiving input signal from users. The touch panel includes one or a plurality of touch sensors for sensing gestures on the touch panel, for example, touching and sliding, etc. The touch sensor not only can sensor trip boundary of touching or sliding, but also can detect the duration and pressure related to the touching or sliding operation. In some embodiments, the multimedia component 908 includes a front-facing camera and/or a rear-facing camera. When the device 900 is under an operation mode, for example, capture mode or video mode, the front-facing camera and/or the rear-facing camera may receive external multimedia data. Each front-facing camera and rear-facing camera may include a fixed optical lens system or have focal length and optical zoom capacity.

The audio component 910 is configured to output and/or input audio signal. For example, the audio component 910 includes a microphone (MIC); when the device 900 is under an operation mode such as call mode, record mode and speech recognition mode, the microphone is configured to receive external audio signal. The audio signal received may include further stored in the memory 904 or sent out by the communication component 916. In some embodiments, the audio component 910 also includes a loudspeaker for outputting audio signal.

The I/O interface 912 provides interface for the processor component 902 and peripheral interface modules, and the peripheral interface modules may include a keyboard, a click wheel and buttons, etc. These buttons may include but are not limited to: home button, volume button, start button and locking button. The above disclosed modules and submodules may be implemented by hardware, software, or a combination of both software and hardware. For example, the modules and submodules may be implemented by circuitries including different integrated circuits.

The sensor component 914 includes one or a plurality of sensors for providing the device 900 with state evaluation from all aspects. For example, the sensor component 914 may detect the on/off state of the device 900, relative positioning of components, for example, the components are the displayer and keypads of the device 900; the sensor component 914 may also detect the position change of the device 900 or of a component thereof, the presence or absence of users' touch on the device 900, the direction or acceleration/deceleration of the device 900, and temperature variation of the device 900. The sensor component 914 may also include a proximity detector, which is configured to detect the presence of nearby objects in case of no physical touch. The sensor component 914 may also include an optical sensor, for example, CMOS or CCD image sensor for imaging. In some embodiments, the sensor component 914 may also include an acceleration sensor, a gyro sensor, a magnetic sensor, a pressure sensor, or a temperature sensor.

The communication component 916 is configured to facilitate wired communication or wireless communication between the device 900 and other equipment. The device 900 is available for access to wireless network based on communication standards, for example, WiFi, 2G or 3G, or combination thereof. In an exemplary embodiment, the communication component 916 receives by means of a broadcast channel the broadcast signal or broadcast-related information from external broadcast management systems. In an exemplary embodiment, the communication component 916 also includes a near field communication (NFC) module for promoting short-range communication. For example, the NFC module may include realized on the basis of Radio Frequency Identification (RFID) Technology, Infrared Data Association (IrDA) Technology, Ultra-wide Bandwidth (UWB) Technology, Bluetooth (BT) Technology and other technologies.

In exemplary embodiments, the device 900 may be implemented by one or more application specific integrated circuits (ASIC), digital signal processors (DSP), digital signal processing equipment (DSPD), programmable logic devices (PLD), field programmable gate arrays (FPGA), controllers, microcontrollers, microprocessors or other electronic components, configured to execute the disclosed communication message recognition method.

In exemplary embodiments, there is also provided a non-transitory computer-readable storage medium including instructions, for example, a memory 904 including instructions, which may include executed by the processors 918 of the device 900 so as to achieve the disclosed communication message recognition method. For example, the non-transitory computer-readable storage medium may include ROM, random access memory (RAM), CD-ROM, a magnetic tape, a floppy disk and an optical data storage device, etc.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary embodiments only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A message recognition method, comprising:
receiving, by a terminal, a communication message that comprises text content and a number associated with a sender of the message;
analyzing, by the terminal, the text content of the communication message and, based on the text content, acquiring a user name corresponding to the number associated with the sender; and
determining, by the terminal, the user name as a name of the communication message sender and displaying the name of the sender in the communication message.

2. The method of claim 1, wherein analyzing the text content of the communication message and acquiring the user name corresponding to the number associated with the sender comprises:
detecting whether the text content of the communication message comprises a preset designator; and
determining the content of the preset designator as a user name corresponding to the number associated with the sender if the text content of the communication message has a preset designator.

3. The method of claim 1, wherein analyzing the text content of the communication message and acquiring the user name corresponding to the number associated with the sender comprises:
detecting whether the text content of the communication message comprises a preset designator; and
sending both the content of the preset designator and the number associated with the sender to a server if the text content of the communication message comprises a preset designator, and receiving the user name corresponding to the number associated with the sender fed back by the server, the user name being acquired by the server by making a comparison between the content of the preset designator and a user name in a name database.

4. The method of claim 1, wherein analyzing the text content of the communication message and acquiring a user name corresponding to the number associated with the sender comprises:
making a semantic analysis of the text content of the communication message and acquiring an executor′ name of the text content, and determining the executor's name as a user name corresponding to the number associated with the sender.

5. The method of claim 1, wherein analyzing the text content of the communication message and acquiring a user name corresponding to the number associated with the sender comprises:
making a term partitioning of the text content of the communication message and acquiring at least one independent term;
sending the at least one independent term acquired from the term partitioning and the number associated with the sender to a server; and
receiving the user name corresponding to the number associated with the sender fed back by the server, the user name being acquired by the server by making a comparison between the at least one independent term and a user name in a name database.

6. The method according to claim 1, further comprising:
sending the number associated with the sender and a corresponding relationship between the number associated with the sender and a user name corresponding to the number associated with the sender to a server, the server being configured to store the corresponding relationship in a corresponding relational database comprising at least one set of corresponding relationship each of which comprises a sender's number and a user name corresponding to the number associated with the sender.

7. The method according to claim 2, further comprising:
sending the number associated with the sender and a corresponding relationship between the number associated with the sender and a user name corresponding to the number associated with the sender to a server, the server being configured to store the corresponding relationship in a corresponding relational database comprising at least one set of corresponding relationship each of which comprises a sender's number and a user name corresponding to the number associated with the sender.

8. The method according to claim 3, further comprising:
sending the number associated with the sender and a corresponding relationship between the number associated with the sender and a user name corresponding to the number associated with the sender to the server, the server being configured to store the corresponding relationship in a corresponding relational database comprising at least one set of corresponding relationship each of which comprises a sender's number and a user name corresponding to the number associated with the sender.

9. A communication message recognition device, comprising:
a processor; and
a memory configured to store instructions executable by the processor;
wherein the processor being configured to perform acts comprising:
receiving a communication message, which comprises text content and a number of a sender who sends the communication message;
analyzing the text content of the communication message and acquiring a user name corresponding to the number of the communication message sender; and
determining the user name as a name associated with the sender and displaying the name of the sender in the communication message.

10. The device of claim 9, wherein analyzing the text content of the communication message and acquiring a user name corresponding to the number of the communication message sender comprises:
detecting whether the text content of the communication message comprises a preset designator; and
determining the content of the preset designator as a user name corresponding to the number of the communication message sender if the text content of the communication message comprises a preset designator.

11. The device of claim 9, wherein analyzing the text content of the communication message and acquiring a user name corresponding to the number of the communication message sender comprises:
detecting whether the text content of the communication message comprises a preset designator; and
sending both the content of the preset designator and the number of the sender to a server if the text content of the communication message comprises a preset designator, and receiving the user name corresponding to the number of the sender fed back by the server, the user name being acquired by the server by making a comparison between the content of the preset designator and a user name in a name database.

12. The device of claim 9, wherein analyzing the text content of the communication message and acquiring a user name corresponding to the number of the communication message sender comprises:
making a semantic analysis of the text content of the communication message and acquiring an executor′ name of the text content, and determining the executor's name as a user name corresponding to the number of the communication message sender.

13. The device of claim 9, wherein analyzing the text content of the communication message and acquiring a user name corresponding to the number of the communication message sender comprises:
making a term partitioning of the text content of the communication message and acquiring at least one independent term;
sending the at least one independent term acquired from the term partitioning and the number of the sender to a server; and
receiving the user name corresponding to the number of the sender fed back by the server, the user name being acquired by the server by making a comparison between the at least one independent term and a user name in a name database.

14. The device according to claim 9, wherein the processor is configured to perform:
sending the number of the sender and a corresponding relationship between the number of the sender and a user name corresponding to the number of the sender to a server, the server being configured to store the corresponding relationship in a corresponding relational database comprising at least one set of corresponding relationship each of which comprises a sender's number and a user name corresponding to the number of the sender.

15. The device according to claim 10, wherein the processor is configured to perform:
sending the number of the sender and a corresponding relationship between the number of the sender and a user name corresponding to the number of the sender to a server, the server being configured to store the corresponding relationship in a corresponding relational database comprising at least one set of corresponding relationship each of which comprises a sender's number and a user name corresponding to the number of the sender.

16. The device according to claim 11, wherein the processor is configured to perform:
sending the number of the sender and a corresponding relationship between the number of the sender and a user name corresponding to the number of the sender to the server, the server being configured to store the corresponding relationship in a corresponding relational database comprising at least one set of corresponding relationship each of which comprises a sender's number and a user name corresponding to the number of the sender.

17. A non-transitory storage medium having stored therein instructions that, when executed by a processor of an electronic device, cause the electronic device to perform acts comprising:
receiving a communication message, which comprises text content and a number of a sender who sends the communication message;
analyzing the text content of the communication message and acquiring a user name corresponding to the number of the communication message sender and
determining the user name as a name of the communication message sender and displaying the name of the sender in the communication message.

18. The medium of claim 17, wherein analyzing the text content of the communication message and acquiring a user name corresponding to the number of the communication message sender comprises:
detecting whether the text content of the communication message comprises a preset designator; and
determining the content of the preset designator as a user name corresponding to the number of the communication message sender if the text content of the communication message comprises a preset designator.

19. The medium of claim 17, wherein analyzing the text content of the communication message and acquiring a user name corresponding to the number of the communication message sender comprises:
detecting whether the text content of the communication message comprises a preset designator; and
sending both the content of the preset designator and the number of the sender to a server if the text content of the communication message comprises a preset designator, and receiving the user name corresponding to the number of the sender fed back by the server, the user name being acquired by the server by making a comparison between the content of the preset designator and a user name in a name database.

20. The medium of claim 17, wherein analyzing the text content of the communication message and acquiring a user name corresponding to the number of the communication message sender comprises:
making a semantic analysis of the text content of the communication message and acquiring an executor' name of the text content, and determining the executor's name as a user name corresponding to the number of the communication message sender.
